(19) United States
(12) Patent Application Publication
(10) Pub. No.: US 2023/0056017 A1
(43) Pub. Date: Feb. 23, 2023

(54) METHOD AND APPARATUS FOR DETECTING ABNORMAL ROAMING REQUEST

(71) Applicant: KOREA INTERNET & SECURITY AGENCY, Naju-si (KR)

(72) Inventors: Do Won KIM, Naju-si (KR); Seong Min PARK, Naju-si (KR); Hyung Jin CHO, Naju-si (KR); Young Kwon PARK, Naju-si (KR); Dae Un KIM, Naju-si (KR); Sung Moon KWON, Naju-si (KR)

(21) Appl. No.: 17/849,406

(22) Filed: Jun. 24, 2022

(30) Foreign Application Priority Data
Aug. 18, 2021 (KR) 10-2021-0108932

(51) Int. Cl. H04W 12/122; H04W 8/12; H04W 12/088; H04W 12/104; H04W 12/61; H04W 12/63

(52) U.S. Cl. CPC H04W 12/122; H04W 8/12; H04W 12/088; H04W 12/104; H04W 12/61; H04W 12/63

(57) ABSTRACT

The exemplary embodiments of the present disclosure provide a method and an apparatus for detecting an abnormal roaming request which acquires information of user equipment which sends a roaming request message, calculates a risk of the roaming request message using a roaming request location and a roaming request time of the user equipment, and safely processes the request according to the risk.

### CROSS-REFERENCE TO RELATED APPLICATIONS

This application claims priority to and the benefit of Korean Patent Application No. 10-2021-0108932 filed in the Korean Intellectual Property Office on Aug. 18, 2021, the entire contents of which are incorporated herein by reference.

### TECHNICAL FIELD

A technical field of the present disclosure relates to a method and an apparatus for detecting an abnormal roaming request message. This study was related to the development of intelligent 5G core network abnormal attack detection and response technology (No. 2019-0-00793) for preventing cyber-attacks on the national infrastructure, which is an information security core source technology development project supported by the Institute of information and communications technology planning & evaluation with the fund of the Ministry of Science and ICT.

### BACKGROUND ART

The contents described in this section merely provide background information on the present exemplary embodiment but do not constitute the related art.

A mobile network is a key tool used to perform usual activity from voice and text messaging to providing signals to the emergency service and the important infrastructure. The process of making voice calls in the modern mobile network is based on a signaling system No 7 (SS7) technology designed in the 1970s.

SS7is a protocol which is used by most carriers in the world to communicate with each other. At the time of design, there were only a handful of carriers, and the telecommunication business was managed by a government or was actually a large corporation. They trusted each other so that authentication function was not embedded. Today anyone can be a carrier (for example, VoIP), which makes it easier to get SS7 access.

The SS7 protocol has a security vulnerability. Attackers launch various attacks against the mobile network and their subscribers to send, intercept, and alter the SS7 messages.

It is a trend to use low security level protocols to interwork with other countries' networks. When domestic and international interworking network section protocols are used, threats such as leakage of user equipment information and personal information or location estimation may occur.

The attacks using the roaming request protocol vulnerability during the overseas roaming access use a characteristic that when the user equipment accesses the overseas home subscriber server (HSS) at the time of roaming, an overseas home subscriber server requests the information to the domestic home subscriber server to request the user equipment information.

### RELATED ART DOCUMENT

### Patent Document

Patent Document 1: Korean Registered Patent Publication No. 10-1329005 (Nov. 1, 2013)

Patent Document 2: Korean Registered Patent Publication No. 10-1154942 (Jun. 4, 2012)

Patent Document 3: Korean Registered Patent Publication No. 10-1828509 (Feb. 6, 2018)

### SUMMARY OF THE INVENTION

A major object of the exemplary embodiments of the present disclosure is to acquire information of user equipment which sends a roaming request message, calculate a risk of the roaming request message using a roaming request location and a roaming request time of the user equipment, and safely process the request according to the risk.

Other and further objects of the present invention which are not specifically described can be further considered within the scope easily deduced from the following detailed description and the effect.

According to an aspect of the present embodiment, an abnormal roaming request detecting method includes: acquiring information of user equipment which sends a roaming request message; and calculating a risk of the roaming request message using a roaming request location and a roaming request time of the user equipment.

The roaming request message may be detected from traffics which passes through a gateway location register (GLR).

The roaming request message may be a message which is requested from a home subscriber server (HSS) of an overseas network to a home subscriber server (HSS) of a domestic network.

The roaming request message may be a message which is requested from a subscriber server of an overseas network to a mobility management entity (MME) of a domestic network.

In the acquiring of information of user equipment, the insert subscriber data request message is requested to the mobility management entity which finally accesses the domestic network to call the domestic final access time of the user equipment.

The risk includes a first risk according to the roaming request location, a second risk according to the roaming request time, and a final risk having a combination thereof.

In the calculating of a risk, if the roaming request location of the user equipment is in a reference area, the first risk is set to be high.

The reference area may be set in a predetermined radius range from a port or an airport.

If the roaming request time in a roaming call country is an abnormal time, in the step of calculating a risk, the second risk is set to be high.

In the calculating of a risk, if a time obtained by subtracting the domestic last access time from the roaming request time is shorter than an average travel time to the roaming call country, the second risk may be set to be high.

The final risk may be classified into (i) a first state in which the first risk is low and the second risk is low, (ii) a second state in which the first state is low and the second risk is high or the first state is high and the second risk is low, and (iii) a third state in which the first risk is high and the second risk is high.

The abnormal roaming request detecting method may include a step of processing the roaming request message based on the risk.

In the step of processing a roaming request message, the roaming request message is blocked according to the risk and a manager is notified that the roaming request message is abnormal.

In the step of processing the roaming request message, a home subscriber server (HSS) of an overseas network which sends the roaming request message is classified as a fake home subscriber server to be managed.

According to another aspect of the present embodiment, an abnormal roaming request detecting apparatus includes a communication interface configured to acquire information of user equipment which sends a roaming request message; and a processor configured to calculate a risk of the roaming request message using a roaming request location and a roaming request time of the user equipment.

According to still another aspect of the present embodiment, as a computer readable storage medium which stores a computer program which is executable by the computer, a computer readable storage medium in which a computer program which is capable of executing the abnormal roaming request detecting method is recorded is provided.

According to still another aspect of the present embodiment, provided is a computer program recorded in a computer readable storage medium including computer program instructions executable by the processor in which when the computer program instructions are executed by the processor, the abnormal roaming request detecting method is performed.

As described above, according to the exemplary embodiments of the present disclosure, it is possible to acquire information of user equipment which sends a roaming request message, calculate a risk of the roaming request message using a roaming request location and a roaming request time of the user equipment, and safely process the request according to the risk.

Even if the effects are not explicitly mentioned here, the effects described in the following specification which are expected by the technical features of the present disclosure and their potential effects are handled as described in the specification of the present disclosure.

### BRIEF DESCRIPTION OF THE DRAWINGS

FIG. 1 is a view illustrating an attack scenario in an overseas roaming access situation;

FIG. 2 is a block diagram illustrating an abnormal roaming request detecting apparatus according to an exemplary embodiment of the present disclosure;

FIGS. 3 and 4 are flowcharts illustrating an abnormal roaming request detecting method according to another exemplary embodiment of the present disclosure;

FIG. 5 is a view illustrating a first risk applied to an abnormal roaming request detecting method according to another exemplary embodiment of the present disclosure;

FIG. 6 is a view illustrating a second risk applied to an abnormal roaming request detecting method according to another exemplary embodiment of the present disclosure; and

FIG. 7 is a view illustrating a final risk applied to an abnormal roaming request detecting method according to another exemplary embodiment of the present disclosure.

### DETAILED DESCRIPTION OF THE EMBODIMENT

Hereinafter, in the description of the present disclosure, a detailed description of the related known functions will be omitted if it is determined that the gist of the present disclosure may be unnecessarily blurred as it is obvious to those skilled in the art and some exemplary embodiments of the present disclosure will be described in detail with reference to exemplary drawings.

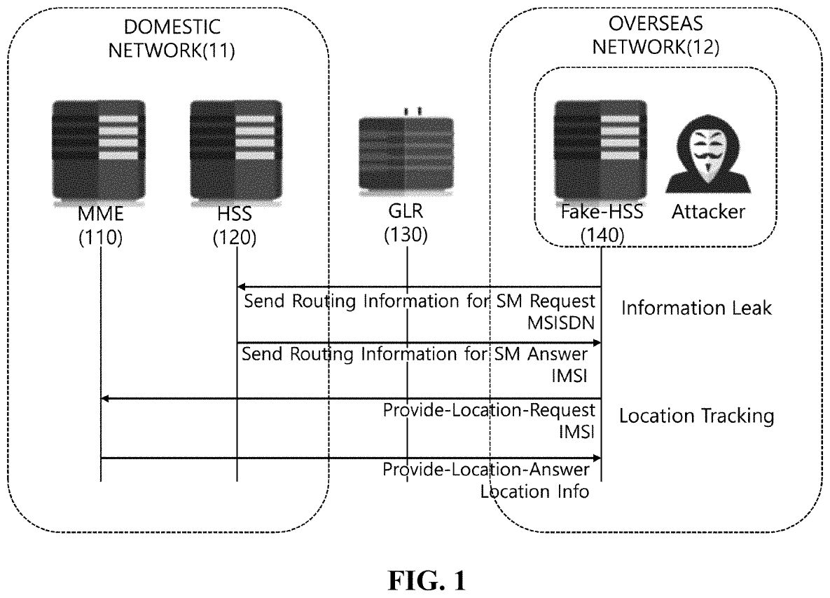

FIG. 1 is a view illustrating an attack scenario in an overseas roaming access situation.

When domestic network 11—overseas network 12 interworking section protocols are used, threats such as leakage of user equipment information and personal information or location estimation may occur by attackers.

The attacks using the roaming request protocol vulnerability during the overseas roaming access use a characteristic that when the user equipment accesses the overseas home subscriber server (HSS) 140 at the time of roaming, the overseas home subscriber server (HSS) 120 requests the corresponding user equipment information to the domestic home subscriber server.

The user equipment (UE) is considered as a user terminal and may be implemented by a phone such as a smart phone or implemented by another device such as USBs, notebooks, and internet usable devices with the purpose of data communication. The user equipment may be implemented by universal subscriber identity module (USIM) card in which international mobile subscriber identity (IMSI) for subscriber identification and authentication.

A mobility management entity (MME) 100 processes subscriber's movement status management, access status, location registration, authentication, and call-related control signals. MME authenticates UE. Key information is in the HSS and the key information is received from the HSS to perform UE authentication. MME is involved in the creation, change, release of a communication tunnel created in a network equipment section to allow the UE to use the Internet.

The home subscriber server (HSS) is a database of a network which manages subscriber related information (location information, authentication information, and service information) and has key information and a subscriber profile for authentication for every US (subscriber). There is QoS level information (priority or available maximum bandwidth) suitable for a service product subscribed by each subscriber in the subscriber profile.

A gateway location register (GLR) 130 is equipment which serves as a gateway at the time of exchanging subscriber location information or a profile at the boundary of a home network and a visited network during the subscriber roaming. During the overseas roaming performed by the domestic subscriber, GLR performs a home location register (HLR) function as the switchboard of the home network and performs a switchboard function of an overseas network for the HLR of the home network. GLR may perform a message converting function between equipment to minimize network equipment alteration for roaming.

The attacker using SS7 does not need delicate equipment. The attacker may use a Linux based computer which is widely used to generate an SS7 packet and a publically available SDK. After performing an initial attack using the SS7 command, the attacker may perform additional attacks in the same way. For example, if an attacker succeeds in locating a subscriber, it takes only one step of intercepting SMS messages and committing fraud. The attack is performed based on legitimate SS7 message so that the message used for the attack cannot be filtered.

There are various attacking scenarios using SS7.

There is an IMSI launching attach. This attack is aimed at analyzing a network of a service provider to obtain subscriber information. The subscriber is identified by international mobile subscriber identity which is considered as confidential information in the mobile network. This attack is based on MSC (mobile switching center) VLR (visitor location register) address and IMSI request. The request is a part of SMS transfer protocol, which allows a source network to receive information about a location of the subscriber for additional routing of a message. Initial data includes a target subscriber number. The attacker acquires subscriber's IMSI, MSC/VLR address service, and home location register (HLR) address having account data of the subscriber.

There is a subscriber location launching attack. This attack is aimed at determining a subscriber's location. This attack is based on an unauthorized request for a subscriber's location. Reception data is used for real-time charging of subscribers' incoming calls. Initial data is IMSI and current MSC/VLR address which is obtained by conducting the IMSI launching attack. The attacker may acquire a mobile country code (MCC), a mobile network code (MNC), a location area code (LAC), and a cell ID (CID).

There is a subscriber service disruption attack. According to this attack, a subscriber needs to be registered in a fraud MSC/VLR coverage area. When the subscriber is registered in the network for roaming, a similar process is generated. Used initial data is IMSI and a current MSC/VLR address.

There is a reception SMS message interception attack. This attack is aimed at intercepting a reception SMS message of a subscriber. This attack corresponds to expansion of a subscriber service disruption attack. After registering a subscriber in a fake MSC/VLR, an SMS message for a subscriber is transmitted to a host of the attacker. The attacker may perform behaviors of sending a confirmation to receive the message (it is displayed to a sender as if the message is delivered), registering a subscriber again in a previous switch to allow the subscriber to receive the message, or sending a confirmation message to the sender, re-registering the subscriber in the previous switch, and sending an altered message. The attacker may steal a one-time mobile banking password delivered as an SMS message or intercept passwords used for various internet services (e-mails or social networks).

There is an USSD request manipulation attack. This attack is aimed at directly sending the USSD request to the HLR. This attack is a good example which uses a legitimate message together with an USSD request sent from VLR to HLR. Initial data is a target subscriber number, an HLR address, and USSD characteristic strings. The subscriber number is usually known from the start, the HLR address is obtained from the IMSI launching attack, and the USSD request is described on the service provider's site. The most dangerous scenario associated with this attack is sending a money transfer request between subscriber accounts. Even though a service provider sends SMS notifications about transactions, this task may not be noticeable for quite long time. In order to block this notification, this attack may be combined with the reception SMS message interception attack.

There is a subscriber profile manipulation attack of the VLR. This attack is aimed at spoofing the network with fake subscriber profile data. When the subscriber is registered in the switch, a corresponding profile is copied from HLR database to VLR database. The profile includes information about an active and inactive subscriber service, call forwarding parameters, and online billing platform address. The attacker may send a fake subscriber profile to the VLR. Initial data includes a target subscriber number, a subscriber IMSI, a VLR address, and subscriber profile detailed information. The subscriber number is generally known from the start. The IMSI and VLR address are obtained from IMSI launching attack and the subscriber profile detailed information is found from a section subscriber service description attack. The fake profile deceives and alters the MSC/VLR and causes the subscriber to provide a service based on a fraud parameter. For example, the subscriber may make voice calls bypassing the billing system. This attack scenario is used to intercept the communication of the target subscriber.

There is an outgoing call interception attack. This attack redirects outgoing subscriber voice calls and data messages to a device of an attacker. This attack corresponds to an expansion of a subscriber profile manipulation attack of the VLR. The attacker replaces a billing platform address with an attacker's equipment address in a subscriber profile. When a subscriber makes a call, a billing request is transmitted to the attacker's equipment together with a destination subscriber number. Thereafter, the attacker redirects the call and creates a three-way (a target subscriber, a calling subscriber, and an attacker) conference call. The attacker intercepts the voice call between two authorized subscribers to illegally participate.

There is a reception call redirection attack. This attack is aimed at changing a voice call routing and redirecting the incoming call. This attack relates to an incoming call and corresponds to an expansion of a subscriber service disruption attack. When the call ends, a gateway MSC (GMSC) sends a request to the HLR to identify the MSC/VLR which provides a service to the current subscriber. This data is necessary to route the call to an appropriate switch. After successfully conducting the attack in the subscriber service disruption attack, the HLR redirects the received request to the fake MSC/VLR, which sequentially transmits mobile station roaming numbers (MSRN) to redirect the calling. HLR transmits this number to GMSC and GMSC redirects the call to the provided MSRN. The attacker may redirect the call. The attacker redirects the incoming call to an arbitrary number. This attack may cost much more if calls are redirected to expensive international numbers. The attacker may sell the calling traffic using this plan.

There is a denial of MSC service attack for an incoming call. This attack is aimed at service denial for an incoming MSC call. This attack is based on a procedure of allocating a roaming number (MSRN) when a voice call is received. When a call is received, after identifying the MSC/VLR of the current subscriber, a voice channel is set to this switch using a temporary roaming number. Generally, the roaming number lasts for a few seconds. When the attacker sends a larger number of roaming number requests to the switch using a basic parameter, a pool of available numbers runs out quickly. As a result, the switch cannot handle the incoming mobile calls. The initial data includes a subscriber IMSI and a switch address which is obtained from the IMSI launching attack. All subscribers in a service area of a switch which is affected by the result of the attack may lose the call service.

Mobile application part (MAP) is a part of SS7 which designates an additional signal (roaming or SMS) required to operate a cellular phone and a roaming contact is usually necessary for two network operators to communicate MAPs with each other.

Anyone with SS7/MAP access for voice call or short message service which may start with a phone numbers from almost everywhere of the global SS7 network may find a location of the subscriber.

An attacker or a corporation may send MAP-SEND-ROUTING-INFO-SM request to the HLR. There is no relevant between the request of the routing information for the message and actual sending of the message. SMS is directly transmitted to MSC which is currently used in the SMSC of the sender. IMSI (actual phone number), global title of the MSC in use, and a user error (for example, subscriber absent=cellular phone is off) are returned.

A mobile switch center (MSC) handles the call and the SMS. Only a specific amount of calls can be handled, so that there may be one or more MSCs for each network in the large city. The global title of the MSC starts with a country code so that it notifies a current country. A mobile network of the corresponding country may be identified by an area code.

The subscriber's location cannot be relieved. There are several companies which provide search service so that when MSISDN is sent to the searching companies, the searching companies perform the MAP-SENDROUTING-INFO-FOR-SM request and sends IMSI and MSC. The company receives HLR to transmit to the requester.

### References

“Locating Mobile Phones using Signalling System #7” Tobias Engel <tobias@ccc.de>
“SIGNALING SYSTEM 7 (SS7) SECURITY REPORT” positive technologies

### “LTE Security Disabled—Misconfiguration in Commercial Networks” Merlin Chlosta, David Rupprecht, Thorsten Holz, Christina Popper

“SS7: Locate. Track. Manipulate.” Tobias Engel <tobias@ccc.de>

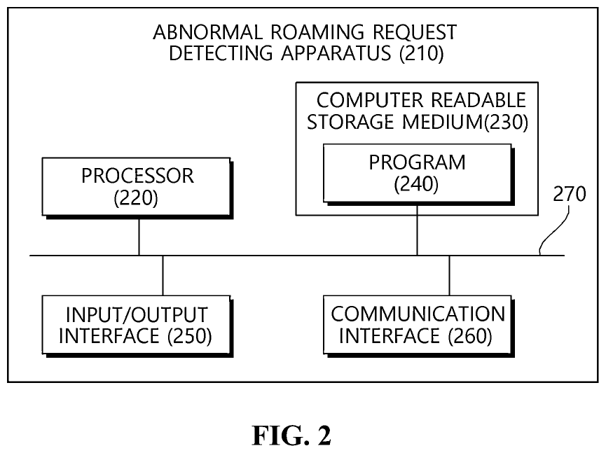

FIG. 2 is a block diagram illustrating an abnormal roaming request detecting apparatus according to an exemplary embodiment of the present disclosure.

The abnormal roaming request detecting apparatus 210 includes at least one processor 220, a computer readable storage medium 230, and a communication bus 270.

The processor 220 controls the abnormal roaming request detecting apparatus 210 to operate. For example, the processor 220 may execute one or more programs stored in the computer readable storage medium 130. One or more programs may include one or more computer executable instructions and the computer executable instruction may be configured to allow the abnormal roaming request detecting apparatus 210 to perform the operations according to the exemplary embodiments when it is executed by the processor 220.

The computer readable storage medium 230 is configured to store a computer executable instruction or program code, program data and/or other appropriate format of information. A computer executable instruction or program code, program data and/or other appropriate type of information may also be provided by an input/output interface 250 or a communication interface 260. The program 230 stored in the computer readable storage medium 240 includes a set of instructions executable by the processor 220. In one exemplary embodiment, the computer readable storage medium 230 may be a memory (a volatile memory such as a random access memory, a non-volatile memory, or an appropriate combination thereof), one or more magnetic disk storage devices, optical disk storage devices, flash memory devices, and another format of storage mediums which is accessed by the abnormal roaming request detecting apparatus 210 and stores desired information, or an appropriate combination thereof.

The communication bus 270 includes a processor 220 and a computer readable storage medium 130 to interconnect various components of the abnormal roaming request detecting apparatus 210 to each other.

The abnormal roaming request detecting apparatus 210 may include one or more input/output interfaces 250 and one or more communication interfaces 260 which provide an interface for one or more input/output devices. The input/output interface 250 and the communication interface 260 are connected to the communication bus 270. The input/output device (not illustrated) may be connected to the other components of the abnormal roaming request detecting apparatus 210 by means of the input/output interface 250.

The abnormal roaming request detecting apparatus 210 detects a message requesting the HSS and MME located in a domestic network, among traffics passing through the GLR. The risk is calculated by comparing the last access location in the domestic network, the last access time, and the overseas travel time using information of user equipment which sends the message.

The communication interface acquires information of the user equipment which sends the roaming request message. The processor calculates a risk of the roaming request message using a roaming request location and a roaming request time of the user equipment.

The risk includes a first risk according to the roaming request location, a second risk according to the roaming request time, and a final risk having a combination thereof.

The abnormal roaming request detecting apparatus 210 acquires current location information of the user equipment which requests the roaming to evaluate whether it is an appropriate location to request the roaming. If the roaming request location of the user equipment is in a reference area, the processor sets the first risk to be high. The reference area may be set in a predetermined radius range from a port or an airport.

The abnormal roaming request detecting apparatus 210 sends an insert subscriber data request message to the MME which finally accesses the domestic network to call a last access time of the user equipment. An average travel time to the roaming request country, a domestic last access time, and a roaming request time are compared to calculate a risk. If the roaming request time in a roaming call country is an abnormal time, the processor sets the second risk to be high. If a time obtained by subtracting the domestic last access time from the roaming request time is smaller than an average travel time to the roaming call country, the second risk may be set to be high. For example, if the roaming call country is Taiwan and an average travel time is 5 hours, when the domestic last access time is May 22 (12:00:00) and a roaming request time is May 22 (14:00:00), the time (two hours) obtained by subtracting the domestic last access time from the roaming request time is smaller than the average travel time (five hours) to the roaming call country, the risk is considered to be high.

The final risk may be classified into (i) a first state in which the first risk is low and the second risk is low, (ii) a second state in which the first state is low and the second risk is high or the first state is high and the second risk is low, and (iii) a third state in which the first risk is high and the second risk is high.

The processor blocks the roaming request message according to the risk and the communication interface notifies the manager than the roaming request message is abnormal. If the risk is high, after blocking the roaming request message, the manager is notified. If the risk is intermediate, the request is notified to the manager. If the risk is low, the corresponding request is performed.

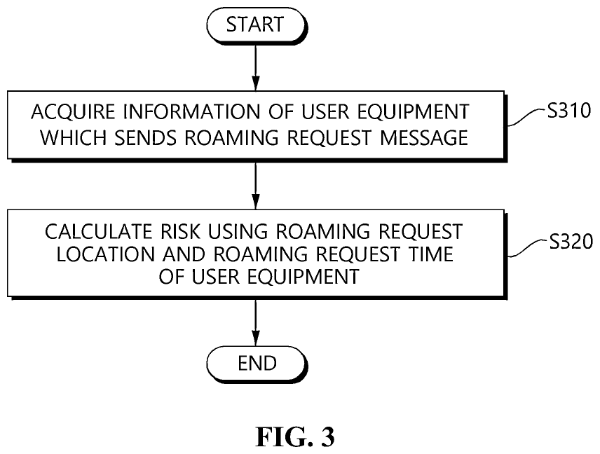

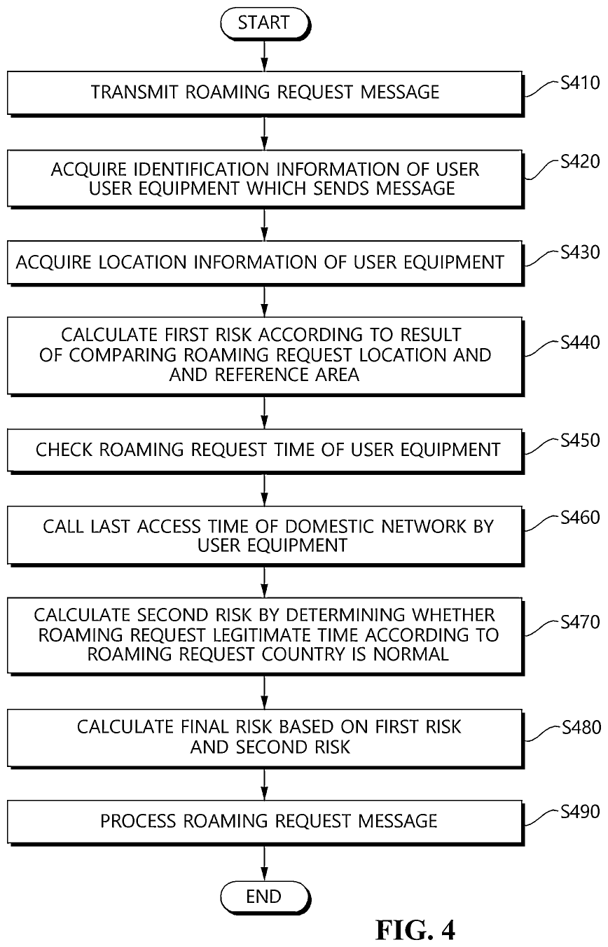

FIGS. 3 and 4 are flowcharts illustrating an abnormal roaming request detecting method according to another exemplary embodiment of the present disclosure. An abnormal roaming request detecting method is performed by the abnormal roaming request detecting apparatus.

Referring to FIG. 3, in step S310, information of user equipment which sends a roaming request message is acquired.

In step S320, a risk of the roaming request message is calculated using a roaming request location and a roaming request time of the user equipment. The risk includes a first risk according to the roaming request location, a second risk according to the roaming request time, and a final risk having a combination thereof.

Referring to FIG. 4, in step S410, the roaming request message is transmitted.

In step S420, identification information of user equipment which sends the roaming request message is acquired. The roaming request message may be detected from traffics which passes through a gateway location register (GLR). The roaming request message may be a message which is requested from a home subscriber server (HSS) of an overseas network to a home subscriber server (HSS) of a domestic network. The roaming request message may be a message which is requested from a subscriber server of an overseas network to a mobility management entity (MME) of a domestic network.

In step S430, location information of user equipment is acquired. A separate request message is sent to the HSS of the overseas network and location information is received and information included in the roaming request message is analyzed and extracted to acquire the location information.

In step S430, the first risk is calculated according to a result of comparing a roaming request location with a reference area. In the step of calculating a first risk, if the roaming request location of the user equipment is in the reference area, the first risk is set to be high.

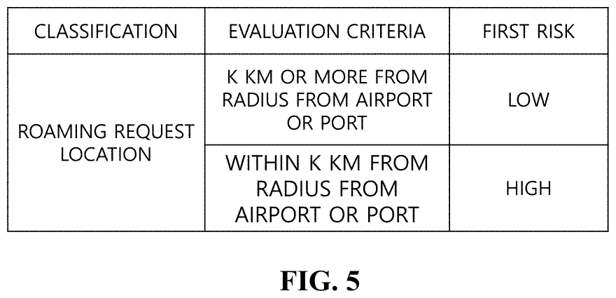

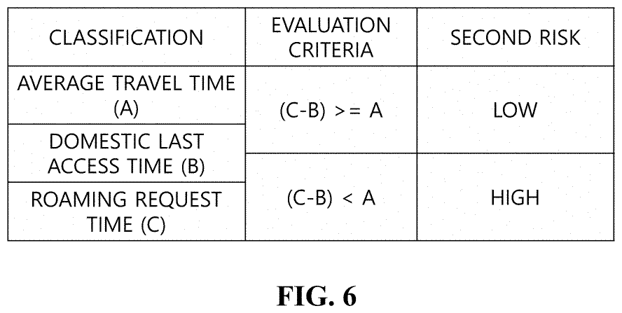

Referring to FIG. 5 illustrating a criterion of determining a first risk, the reference area may be set to be in a predetermined radius range from a port or an airport.

In step S450, a roaming request time of the user equipment is checked. The information included in the roaming request message is analyzed and extracted to acquire the roaming request time.

In step S460, a domestic network final access time of the user equipment is called. In the step of acquiring information of the user equipment, the insert subscriber data request message is requested to the mobility management entity which finally accesses the domestic network to call the domestic final access time of the user equipment.

In step S470, the second risk is calculated by determining whether the roaming request legitimate time according to the roaming request country is normal. If the roaming request time in a roaming call country is an abnormal time, in the step of calculating a risk, the second risk is set to be high.

Referring to FIG. 5 illustrating a criterion of determining a second risk, in the step of calculating a risk, if the time obtained by subtracting the domestic final access time from the roaming request time is shorter than the average travel time to the roaming call country, the second risk is set to be high.

In step S480, the final risk is calculated based on the first risk and the second risk.

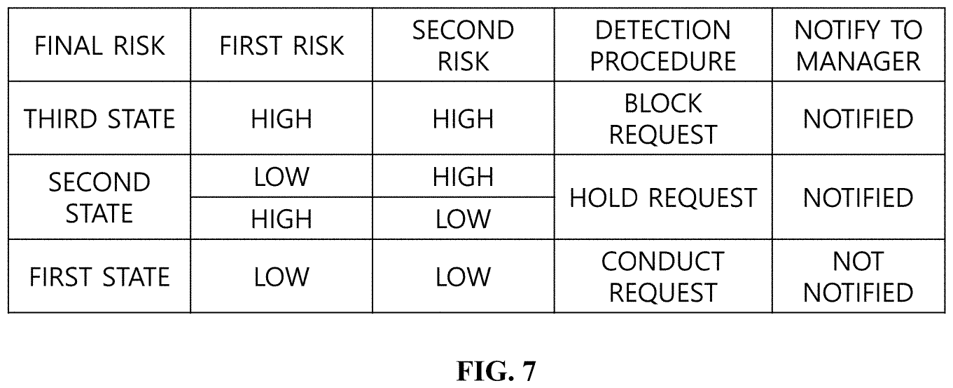

Referring to FIG. 7 illustrating a final risk, the final risk may be classified into (i) a first state in which the first risk is low and the second risk is low, (ii) a second state in which the first state is low and the second risk is high or the first state is high and the second risk is low, and (iii) a third state in which the first risk is high and the second risk is high.

In step S490, the roaming request message is processed. The abnormal roaming request detecting method may include a step of processing a roaming request message based on the risk.

In the step of processing the roaming request message, the roaming request message is blocked according to the risk and notifies the manager than the roaming request message is abnormal. In the step of processing a roaming request message, the home subscriber server (HSS) of an overseas network which sends the roaming request message is classified as a fake home subscriber server to be managed.

The abnormal roaming request detecting apparatus may be implemented in a logic circuit by hardware, firm ware, software, or a combination thereof or may be implemented using a general purpose or special purpose computer. The apparatus may be implemented using hardwired device, field programmable gate array (FPGA) or application specific integrated circuit (ASIC). Further, the apparatus may be implemented by a system on chip (SoC) including one or more processors and a controller.

The abnormal roaming request detecting apparatus may be mounted in a computing device or a server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

In FIGS. 3 and 4, the respective processes are sequentially performed, but this is merely illustrative and those skilled in the art may apply various modifications and changes by changing the order illustrated in FIGS. 3 and 4 or performing one or more processes in parallel or adding another process without departing from the essential gist of the exemplary embodiment of the present disclosure.

The operation according to the exemplary embodiment of the present disclosure may be implemented as a program instruction which may be executed by various computers to be recorded in a computer readable medium. The computer readable medium indicates an arbitrary medium which participates to provide a command to a processor for execution. The computer readable medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

What is claimed is:

1. An abnormal roaming request detecting method comprising:
acquiring information of user equipment which sends a roaming request message; and
calculating a risk of the roaming request message using a roaming request location and a roaming request time of the user equipment.

2. The abnormal roaming request detecting method according to claim 1, wherein the roaming request message is detected among traffics which pass through a gateway location registers (GLR).

3. The abnormal roaming request detecting method according to claim 1, wherein the roaming request message is a message which is requested from a home subscriber server (HSS) of an overseas network to a home subscriber server (HSS) of a domestic network.

4. The abnormal roaming request detecting method according to claim 1, wherein the roaming request message is a message which is requested from a subscriber server of an overseas network to a mobility management entity (MME) of a domestic network.

5. The abnormal roaming request detecting method according to claim 1, wherein in the acquiring of information of user equipment, an insert subscriber data request message is requested to a mobility management entity which finally accesses the domestic network to call a domestic last access time of the user equipment.

6. The abnormal roaming request detecting method according to claim 1, wherein the risk includes a first risk according to the roaming request location, a second risk according to the roaming request time, and a final risk having a combination thereof.

7. The abnormal roaming request detecting method according to claim 6, wherein in the calculating of a risk,
if the roaming request location of the user equipment is in the reference area, the first risk is set to be high.

8. The abnormal roaming request detecting method according to claim 7, wherein the reference area is set to be in a predetermined radius range from a port or an airport.

9. The abnormal roaming request detecting method according to claim 6, wherein in the calculating of a risk,
if a roaming request time in a roaming call country is an abnormal time, the second risk is set to be high.

10. The abnormal roaming request detecting method according to claim 9, wherein in the calculating of a risk,
if a time obtained by subtracting the domestic last access time from the roaming request time is smaller than an average travel time to the roaming call country, the second risk may be set to be high.

11. The abnormal roaming request detecting method according to claim 6, wherein the final risk is classified into (i) a first state in which the first risk is low and the second risk is low, (ii) a second state in which the first state is low and the second risk is high or the first state is high and the second risk is low, and (iii) a third state in which the first risk is high and the second risk is high.

12. The abnormal roaming request detecting method according to claim 1, further comprising:
processing the roaming request message based on the risk,
wherein the roaming request message is blocked according to the risk and a manager is notified that the roaming request message is abnormal.

13. The abnormal roaming request detecting method according to claim 12, wherein in the processing of a roaming request message, a home subscriber server (HSS) of an overseas network which sends the roaming request message is classified as a fake home subscriber server to be managed.

14. An abnormal roaming request detecting apparatus, comprising:
a communication interface configured to acquire information of user equipment which sends a roaming request message; and
a processor configured to calculate a risk of the roaming request message using a roaming request location and a roaming request time of the user equipment.

15. The abnormal roaming request detecting apparatus according to claim 14, wherein the risk includes a first risk according to the roaming request location, a second risk according to the roaming request time, and a final risk having a combination thereof.

16. The abnormal roaming request detecting apparatus according to claim 15, wherein if the roaming request location of the user equipment is in the reference area, the processor sets first risk to be high.

17. The abnormal roaming request detecting apparatus according to claim 15, wherein if a roaming request time in a roaming call country is an abnormal time, the processor sets the second risk to be high.

18. The abnormal roaming request detecting apparatus according to claim 15, wherein the final risk is classified into (i) a first state in which the first risk is low and the second risk is low, (ii) a second state in which the first state is low and the second risk is high or the first state is high and the second risk is low, and (iii) a third state in which the first risk is high and the second risk is high.

19. The abnormal roaming request detecting apparatus according to claim 14, wherein the processor blocks the roaming request message according to the risk and the communication interface notifies a manager that the roaming request message is abnormal.

20. A computer readable storage medium which stores a computer program which is executable by the computer,
in which a computer program which is capable of executing the method of claim 1 is recorded.

21. A computer program recorded in a computer readable storage medium including computer program instructions executable by the processor, wherein when the computer program instructions are executed by the processor, the method according to claim 1 is performed.
